(19) United States
(12) Patent Application Publication
(10) Pub. No.: US 2005/0268021 A1
(43) Pub. Date: Dec. 1, 2005

(54) Method and system for operating a cache memory

(75) Inventors: Gerd Dirscherl, Munich (DE); Berndt Gammel, Markt Schwaben (DE); Michael Smola, Munich (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/153,914

(22) Filed: Jun. 14, 2005

Related U.S. Application Data
(63) Continuation of application No. PCT/DE03/03984, filed on Dec. 3, 2003.

(30) Foreign Application Priority Data
Dec. 16, 2002 (DE) 102 58 767.1

(51) Int. Cl. G06F 12/00

(52) U.S. Cl. 711/3; 711/128

(57) ABSTRACT

Method and system for operating a cache memory. The method includes the steps of splitting the cache memory into sets, addressing the cache memory using a processor address which is split into at least two fields, and forming one of the fields of the processor address for addressing the cache memory from a combinational logic function on a basis of a modulo N operation, where N corresponds to the number of sets in the cache memory.

### CROSS-REFERENCE TO RELATED APPLICATION

This application is a continuation of International Patent Application Serial No. PCT/DE2003/003984, filed Dec. 3, 2003, which published in German on Jul. 1, 2004 as WO 2004/055678, and is incorporated herein by reference in its entirety.

### FIELD OF THE INVENTION

The present invention relates to a method for operating a cache memory whose memory area is split into sets and is addressed using an address which has a first, a second and a third field.

### BACKGROUND OF THE INVENTION

The performance of a processor system is determined, inter alia, by the access times for connected memory systems. Although the speed of the main memories has increased, they are not equal to the processing speeds of modern processors and cannot supply or store data at the required speed. Read or write commands from the processors for the main memory thus bring about “latencies”.

To increase the performance of the overall system, present-day processor architectures contain cache memories, e.g. for data (D cache), instructions (I cache) or addresses (TLB, translation lookaside buffer). Cache memories are generally smaller, i.e. the number of bytes which can be stored, than main memories or external memories. They are fast buffer stores which are used in order to reduce the latency when a processor accesses slow external memories. In this case, the cache memory covers selected address areas in the external memory and contains the temporarily modified data and also information relating to their location.

The textbook Hennessey, Patterson, Computer Architecture, A Quantitative Approach, 2nd Ed. 1996, Morgan Kaufmann, S. F., describes the common cache architectures and their manners of operation. A cache memory comprises an address bank which comprises at least one index or index field, also called a set, and a marker or marker field. The data in a main memory location with the address associated with the main memory are stored in a line in a cache memory. An address for a cache memory has 12 address bits, for example, with the more significant bits (for example 6 more significant bits) forming the marker and the less significant bits (for example 5 less significant bits) forming the index. The data in the main memory are stored together with the marker in a line in the cache memory, which line corresponds to the index of this address. The line in a cache memory thus comprises an address and main memory data which correspond to this address. A line is the smallest unit of information which can be moved between main memory and cache memory and is also called a block. A processor uses the index bits to address the marker bits which are stored in the cache memory. These marker bits are compared with the marker bits of the address generated by the processor. If there is a match, the data corresponding to the address can be read from the cache memory.

The cache memories can be characterized as buffer stores with “N-way set associative”, “direct mapped” or “fully associative” memory arrays.

In the text below, the N-way set associative and direct mapped cache memories will be assumed in this case. With an N-way set associative cache memory, the same memory areas in a main memory are always mapped onto the same sets in a cache memory. The lines in the main memory can be mapped onto different lines within the sets, however, by using LRU (last recent used) algorithms, for example, which select a memory line in the cache memory whose use is furthest back in time in relation to all the memory lines of a set. In the direct mapped cache memory, each memory line in a main memory is assigned a fixed memory line in the cache memory. The arrangement of the areas in the main memory thus corresponds precisely to the arrangement of the memory lines in the cache memory.

Generally, the data are stored in blocks of 2^{b} bytes per memory entry. In the case of an N-way set associative or direct mapped cache memory with N=2ⁿ ways, the memory address is split into a marker field, an index field and an offset field. During a read or write operation in the cache memory, i.e. when a data item is accessed, the index field is used for directly addressing the set. In the case of these cache memories, the stored marker field is used to identify the respective line in the cache, since the set contains a plurality of lines in which a data item is actually stored. The offset field is used to address the data item in the line.

A fundamental drawback with the fixed mapping of memory areas in the main memory onto the sets in the cache memory is firstly that particular configurations of program and data segments in the cache memory involve frequently used blocks being repeatedly expelled from the sets, in which case other sets contained in the cache are utilized less efficiently. This presents a significant performance drawback.

In addition, physical reading methods for the arrangement of the data in the cache memory allow the data in an external memory or main memory to be reconstructed, for example using electron beam analysis. This can be seen as a further significant drawback with regard to physical security, particularly in chip card controllers or other security controllers.

### SUMMARY OF THE INVENTION

It is an object of the present invention to specify a method for operating a cache memory which improves the utilization level of the sets in the cache memory with increased physical security for the cache memory, which means that a relatively long residence time for the blocks in these sets can be achieved.

The inventive method for operating a cache memory whose memory area is split into sets and is addressed using an address which is split into at least two fields involves the second field for addressing the sets in the cache memory being recalculated by performing a combinational logic function on the basis of a modulo N operation, where N corresponds to the number of sets in the cache memory. Calculating a new field for addressing the sets has the advantage that the individual sets within a cache memory can be utilized more beneficially.

### BRIEF DESCRIPTION OF THE DRAWINGS

The inventive method is explained in more detail below using an exemplary embodiment with reference to the figures. Identical or corresponding elements in different figures have been provided with the same reference symbols.

In the figures:

FIG. 1 shows the usual structure of an address for addressing a cache memory;

FIG. 2 shows a program flowchart to explain the method; and

FIG. 3 shows a detail from the program flow described in FIG. 2 with an illustration of the fields of the address or the program parameters required for the combinational logic.

### DETAILED DESCRIPTION OF PREFERRED EMBODIMENTS OF THE INVENTION

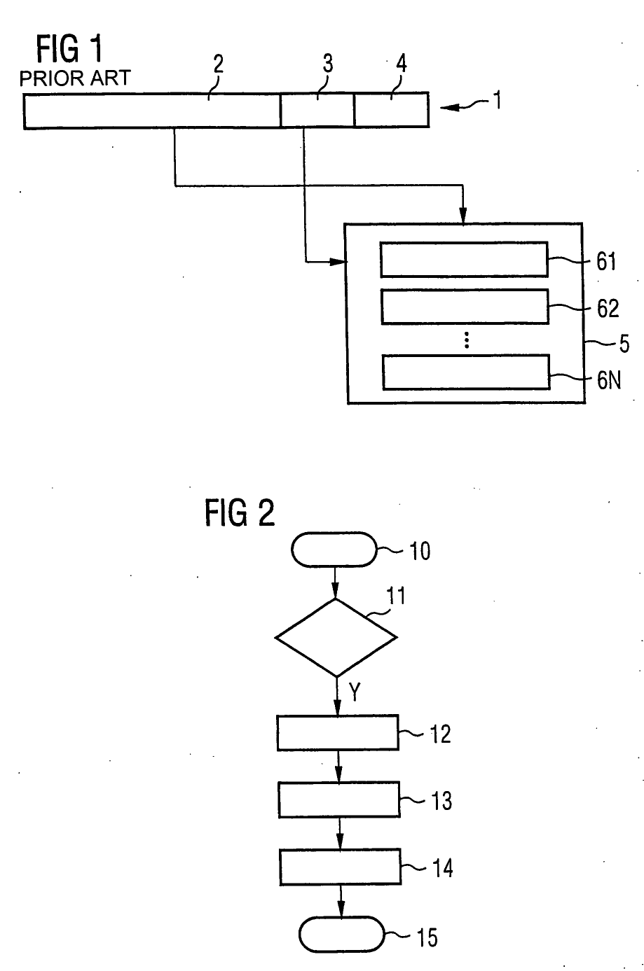

FIG. 1 shows the structure of an address 1 based on the prior art for addressing a cache memory 5. Such an address 1, for example a 32-bit address, is normally generated by a microprocessor (not shown in the present case) for addressing a data block which has a data item. The memory area in the cache memory 5 has the sets 61, 62, 6N, into which the data from a main memory in the microprocessor are stored for processing.

The address 1 is divided into a marker field 2, an index field 3 and an offset field 4. In this case, an arrow pointing from the index field 3 in the address 1 to the cache memory 5 is intended to indicate that the index field 3 is used for addressing the sets 61, 62, 6N in the cache memory 5. The marker field 2 is used to identify the respective line in the cache, since in the case of set associative cache memories the set has a plurality of lines available in which the data item can actually be stored. The marker field 2 of an address generated by a processor (not shown in the present case) is stored together with the respective data, which means that when the data item is pulled the marker field 2 of the address 1 generated by a processor is compared with the stored marker field 2 in the addressed set in order to find the data item in question in this manner.

FIG. 2 shows a program flowchart to explain the method. Following the start 10, there is a test 11 which ascertains whether the processor intends to access the cache memory 5. If the response to the test is “yes”, the address 1 generated by the microprocessor is buffer-stored in a further memory 12. In block 13, the index field 3 is logically combined in any embodiment. By way of example, the combinational logic function can add the marker field 2 and the index field 3 of the address generated by the processor in order to produce a new index field 3. Instead of using all the available bits of the individual fields, the addition can be applied just to portions of the available bits of the marker field and to portions of the available bits of the index field. In another embodiment, the addition involves the use not only of the bits of the marker and index fields but also of a parameter of the program in the combinational logic in order to calculate the new index field. In another embodiment, the combinational logic function Exclusive-Ors the address fields or at least one of the address fields and a program parameter. In one refinement, the bits of the marker and index fields are provided as the address fields' bits which are to be used for the combinational logic. In another refinement, a program parameter is Exclusive-Ored with the bits of the marker and index fields.

In block 14, the address with the new index field 3 is forwarded to the cache memory 5. Block 15 indicates the end of this program flowchart.

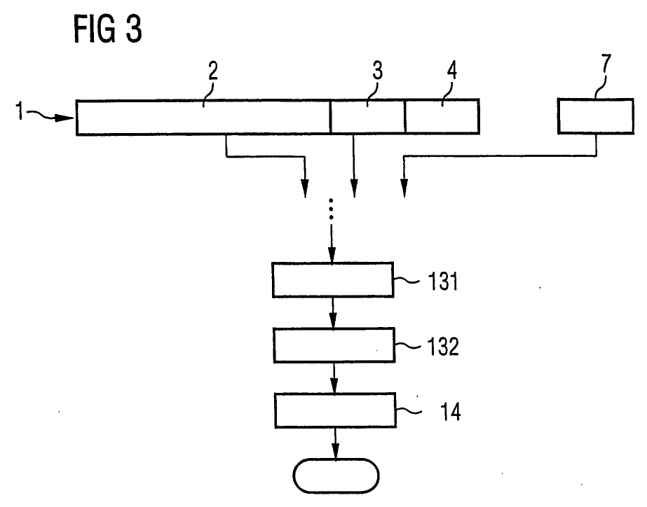

FIG. 3 shows a detail from the program flow described in FIG. 2 with an illustration of the fields 2, 3 of the address or program parameters 7 required for the combinational logic. In block 131, the fields 2, 3 of the address 1 or of the program parameters 7 which are required in line with the embodiment of the combinational logic which is to be implemented, shown by directional arrows in this case, are selected and are logically combined with one another in the combinational logic unit 132, the index field 3 of the address 1 being replaced by a recalculated index field (not shown in the present case). The address is then forwarded to the cache memory 5, and the sets in the cache memory are addressed using this new index field 3 of the address produced by the processor.

The inventive method has the advantage that the combinational logic function can be taken as a basis for calculating a new address field for addressing the sets in the cache memory, so that the utilization level of the individual sets is assisted when the cache memory is in heavy use. Since the stored data can therefore also be stored in other sets, a relatively long residence time for the stored blocks in these sets is also achieved.

The security of security controllers is significantly increased, since the information obtained through physical reading methods for the arrangement of the data in the cache is no longer concurrent in a fresh program cycle, and hence no conclusion can be drawn about the data structure in the main memory.

1. A method for operating a cache memory, comprising the steps of:
splitting the cache memory into sets;
addressing the cache memory using a processor address which is split into at least two fields; and
forming one of the fields of the processor address for addressing the cache memory from a combinational logic function on a basis of a modulo N operation, where N corresponds to the number of sets in the cache memory.

2. The method as claimed in claim 1, wherein the addressing step comprises the steps of:
using a first field in the processor address to identify a memory line within a set; and
using a second field in the processor address to address the set within the cache memory.

3. The method as claimed in claim 2, wherein the field created from the combinational logic function relates to the second field.

4. The method as claimed in claim 1, wherein the combinational logic function adds the address fields or at least one of the address fields and a program parameter.

5. The method as claimed in claim 4, wherein the combinational logic function adds the bits of the marker field to the bits of the index field of the processor address.

6. The method as claimed in claim 4, wherein the combinational logic function adds a portion of the bits of the marker field to a portion of the bits of the index field of the processor address.

7. The method as claimed in claim 4, wherein the combinational logic function adds the bits of the marker field to the bits of the index field of the processor address and a program parameter.

8. The method as claimed in claim 1, wherein the combinational logic function Exclusive-Ors the address fields or at least one of the address fields and a program parameter.

9. The method as claimed in claim 8, wherein the combinational logic function Exclusive-Ors the bits of the marker field and the bits of the index field of the processor address.

10. The method as claimed in claim 8, wherein the combinational logic function Exclusive-Ors the bits of the marker field, the bits of the index field of the processor address and a program parameter.

11. A system for operating a cache memory, comprising:
means for splitting the cache memory into sets;
means for addressing the cache memory using a processor address which is split into at least two fields; and
means for forming one of the fields of the processor address for addressing the cache memory from a combinational logic function on a basis of a modulo N operation, where N corresponds to the number of sets in the cache memory.

12. The system as claimed in claim 1, wherein the means for addressing comprises:
means for using a first field in the processor address to identify a memory line within a set; and
means for using a second field in the processor address to address the set within the cache memory.

13. The system as claimed in claim 12, wherein the field created from the combinational logic function relates to the second field.

14. The system as claimed in claim 11, wherein the combinational logic function adds the address fields or at least one of the address fields and a program parameter.

15. The system as claimed in claim 14, wherein the combinational logic function adds the bits of the marker field to the bits of the index field of the processor address.

16. The system as claimed in claim 14, wherein the combinational logic function adds a portion of the bits of the marker field to a portion of the bits of the index field of the processor address.

17. The system as claimed in claim 14, wherein the combinational logic function adds the bits of the marker field to the bits of the index field of the processor address and a program parameter.

18. The system as claimed in claim 11, wherein the combinational logic function Exclusive-Ors the address fields or at least one of the address fields and a program parameter.

19. The system as claimed in claim 18, wherein the combinational logic function Exclusive-Ors the bits of the marker field and the bits of the index field of the processor address.

20. The system as claimed in claim 18, wherein the combinational logic function Exclusive-Ors the bits of the marker field, the bits of the index field of the processor address and a program parameter.

21. A computer program having a program code for performing a method for operating a cache memory, comprising the steps of: (a) splitting the cache memory into sets; (b) addressing the cache memory using a processor address which is split into at least two fields; and (c) forming one of the fields of the processor address for addressing the cache memory from a combinational logic function on a basis of a modulo N operation, where N corresponds to the number of sets in the cache memory.

22. A system for operating a cache memory, the system comprising:
a processor;
a memory communicatively coupled to the processor; and
software executing in the processor configured to:
a) split the cache memory into sets;
b) address the cache memory using a processor address which is split into at least two fields; and
c) form one of the fields of the processor address for addressing the cache memory from a combinational logic function on a basis of a modulo N operation, where N corresponds to the number of sets in the cache memory.
